(19) United States
(12) Patent Application Publication
(10) Pub. No.: US 2013/0215311 A1
(43) Pub. Date: Aug. 22, 2013

(54) CAMERA DEVICE, ELECTRONIC APPARATUS AND FLEXIBLE CHASSIS

(71) Applicant: Sony Corporation, (US)

(72) Inventor: Yohei Uemura, Kanagawa (JP)

(73) Assignee: Sony Corporation, Tokyo (JP)

(21) Appl. No.: 13/766,581

(22) Filed: Feb. 13, 2013

(30) Foreign Application Priority Data
Feb. 20, 2012 (JP) 2012-033940

(51) Int. Cl. H04N 5/225

(52) U.S. Cl. CPC H04N 5/2253
USPC 348/308; 348/374

(57) ABSTRACT

A camera device includes: a metal panel to be grounded; a main board on which a CMOS imaging device is mounted; a sub board having a ground plane obtained by leading out a ground pattern of the main board through a flexible portion and mounting the led-out ground pattern, which is connected to the main board through the flexible portion; and a metal support plate one surface of which is fixed to the main board through an adhesive layer, wherein the ground plane of the sub board is connected to the other surface of the support plate by bending the flexible plate, which electrically connects the ground pattern of the main board to the panel through the support plate to be grounded.

### FIELD

The present disclosure relates to a camera device performing imaging, an electronic apparatus including electronic components and a flexible chassis on which substrates are mounted.

### BACKGROUND

In recent years, demand of a digital camera using a CMOS (Complementary Metal Oxide Semiconductor) image sensor is increasing. The CMOS image sensor is widely used in a field of a small-sized digital camera and other fields because a general-purpose semiconductor manufacturing apparatus can be utilized more commonly than a CCD (Charge Coupled Device) image sensor, and further, the CMOS image sensor is supplied at low price.

In a digital camera using the CMOS image sensor described above, the CMOS image sensor is incorporated in the device in a state of being mounted on a substrate.

Accordingly, in order to obtain the accuracy of a flange focal length (length from a mount surface of a camera lens mount to the image sensor), there is applied a structure obtained by, first, adhering the substrate on which the CMOS image sensor is mounted to another mechanical component (bracket) and fixing the bracket to a die-cast component by using screws after adjusting the flange focal length.

As a related art concerning the structure in the periphery of the image sensor, there is proposed a technology in which a ground via hole and a ground dummy board are provided on an outer surface of a substrate which electrically connects between the image sensor and a connector to thereby suppress electromagnetic radiation (JP-A-2008-154232 (Patent Document 1)).

### SUMMARY

In a flange-focal length adjustment mechanism unit of the digital camera, the substrate on which the CMOS image sensor is mounted is adhered to the bracket, therefore, an adhesive layer made of resin exists between the substrate and the bracket.

The bracket is electrically connected to a ground as it is made of metal and fixed to the die-cast component which is shielded, however, it is difficult to obtain electrical connection between the substrate and the bracket as there exists the adhesive layer between the substrate and the bracket.

Accordingly, it is difficult to strengthen the ground in the substrate as the ground in the substrate is not electrically connected to the ground through the bracket, there is a problem that the substrate is liable to contain noise.

In related art, a thin-line coaxial cable is led from the substrate on which the CMOS image sensor is mounted and connected to another substrate, thereby securing the ground.

However, as it is necessary to provide a connector for leading out the thin-line coaxial cable on the substrate in the above case, application to small-sized products such as a MV (Machine Vision) camera is difficult.

In view of the above, it is desirable to provide a camera device aiming for improving electrical characteristics by securing the ground.

It is also desirable to provide an electronic apparatus and a flexible chassis aiming for improving productivity by facilitating assembly work.

An embodiment of the present disclosure is directed to a camera device. The camera device includes a panel, a main board, a sub board and a support plate. The panel is made of a metal and grounded. A CMOS imaging device is mounted on the main board. The sub board has a ground plane obtained by leading out a ground pattern of the main board through a flexible portion and mounting the led-out ground pattern, which is connected to the main board through the flexible portion. The support plate is made of a metal and one surface of which is fixed to the main board through an adhesive layer. The ground plane of the sub board is connected to the other surface of the support plate by bending the flexible portion, which electrically connects the ground pattern of the main board to the panel through the support plate to be grounded.

According to the embodiment of the present disclosure, it is possible to improve electrical characteristics by securing the ground.

### BRIEF DESCRIPTION OF THE DRAWINGS

FIG. 1 is a view showing an assembly structure example of a camera device;

FIG. 2 is a view showing the assembly structure example of the camera device;

FIG. 3 is a view showing the assembly structure example of the camera device;

FIG. 4 is a view showing a structure example of a substrate unit;

FIG. 5 is a view showing a structure example of a flexible chassis;

FIG. 6 is a view showing a structure example of the flexible chassis;

FIG. 7 is a view for explaining fixing and installation of substrates by the flexible chassis;

FIG. 8 is a view for explaining fixing and installation of substrates by the flexible chassis;

FIG. 9 is a view for explaining fixing and installation of substrates by the flexible chassis;

FIG. 10 is a view for explaining fixing and installation of substrates by the flexible chassis;

FIG. 11 is a view for explaining fixing and installation of substrates by the flexible chassis;

FIG. 12 is a view for explaining fixing and installation of substrates by the flexible chassis;

FIG. 13 is a view for explaining fixing and installation of substrates by the flexible chassis;

FIG. 14 is a view for explaining fixing and installation of substrates by the flexible chassis;

FIG. 15 is a view for explaining fixing and installation of substrates by the flexible chassis;

FIG. 16 is a view for explaining fixing and installation of substrates by the flexible chassis;

FIG. 17 is a view for explaining fixing and installation of substrates by the flexible chassis;

FIG. 18 is a view for explaining fixing and installation of substrates by the flexible chassis; and

FIG. 19 is a view showing an outline of the camera device.

### DETAILED DESCRIPTION

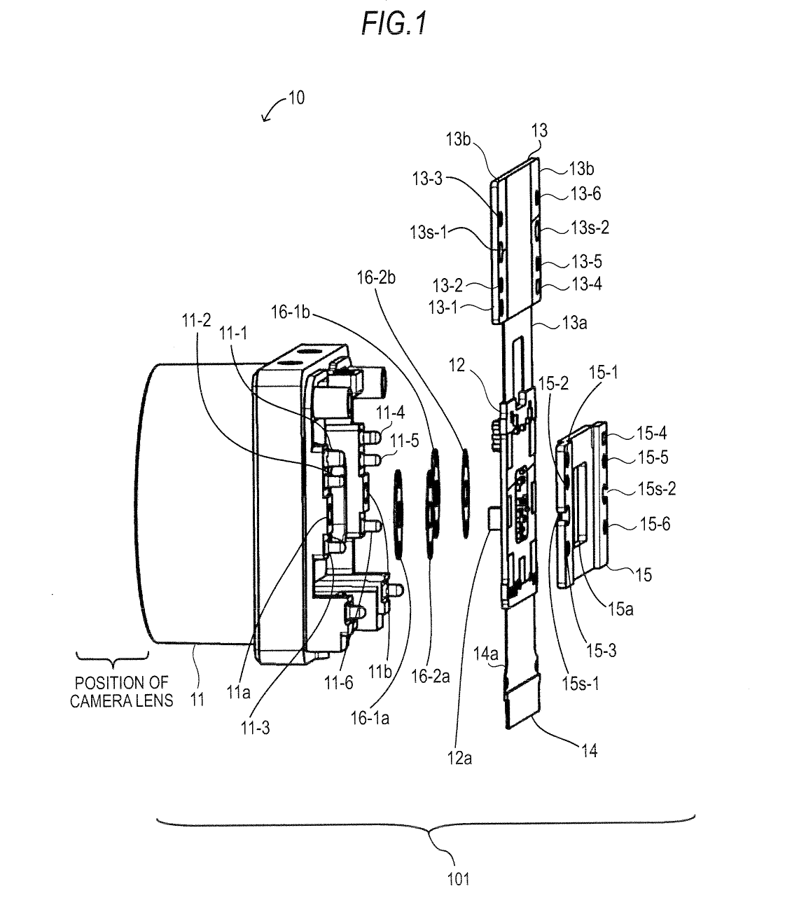

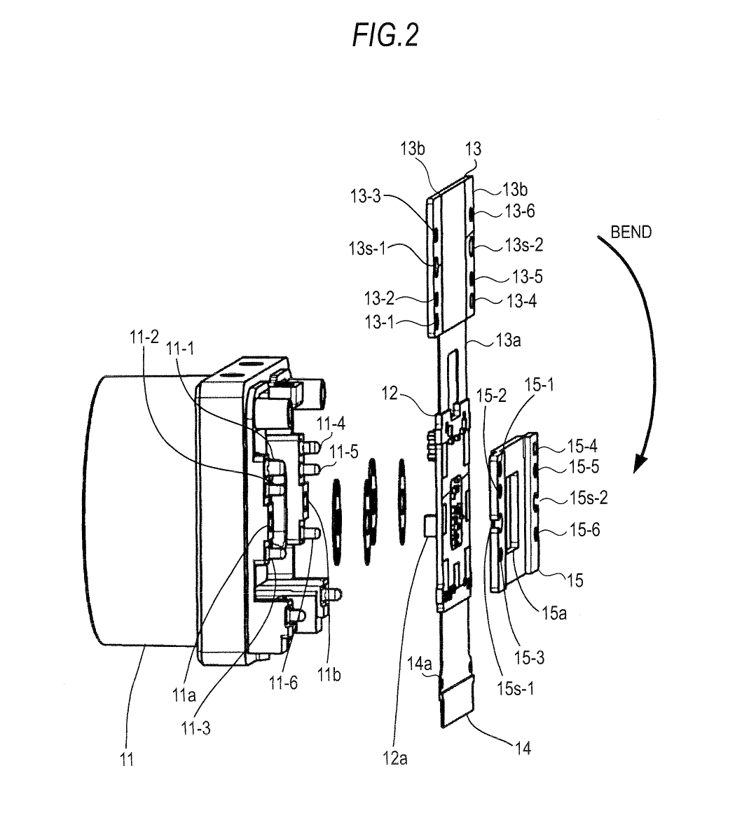

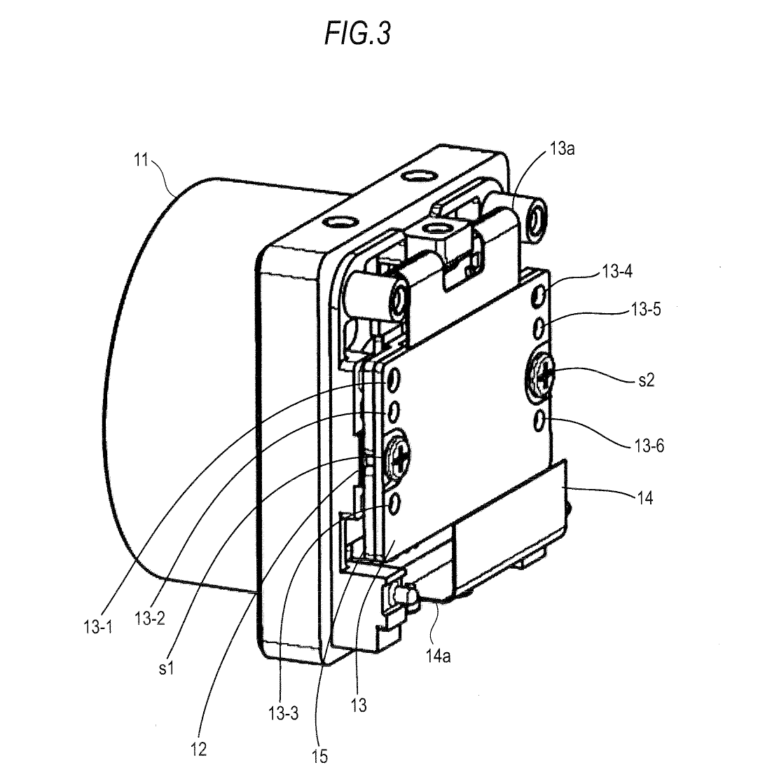

Hereinafter, an embodiment will be explained with reference to the drawings. FIG. 1 to FIG. 3 are views showing an assembly structure example of a camera device. The assembly structure example of a front portion 101 having a flange-focal length adjustment mechanism in a camera device 10 is shown. FIG. 1 shows a state before assembly and FIG. 2 shows a direction of folding a sub board 13. FIG. 3 shows a state after assembly.

The front portion 101 of the camera device 10 includes a panel (hereinafter referred to as a front panel) 11, a main board 12, a sub board 13, a connector 14, a support plate (hereinafter referred to as a bracket) 15 and spacers 16-1a, 16-1b, 16-2a and 16-2b (referred to as spacers 16 when generically called).

The front panel 11 is a panel made by die-casting which surrounds a front surface of the camera device 10. On an interior surface side, screw seats 11a and 11b and protruding portions 11-1 to 11-3, 11-4 to 11-6 are provided.

After the device is assembled, the front panel 11 is shielded and grounded (electrically connected to the ground). Additionally, a camera lens is placed on the left side of the front panel 11, though not shown.

A CMOS imaging device (hereinafter referred to as a CMOS image sensor) 12a is mounted on the main board 12. The sub board 13 is connected to an upper end portion of the main board 12 and the connector 14 is connected to a lower end portion thereof.

The sub board 13 is connected to the main board 12 through a transformable flexible portion 13a having flexibility. A ground pattern (hereinafter referred to as a GND pattern) of the main board 12 is led out through the flexible portion 13a and the led-out GND pattern is mounted on both sides of the sub board 13 as a ground plane (hereinafter referred to as a GND plane) 13b.

Furthermore, screw holes 13s-1 and 13s-2 are respectively provided at positions in the GND plane 13b of the sub board 13 on both ends of right and left. Additionally, holes 13-1 to 13-3, 13-4 to 13-6 into which the protruding portions 11-1 to 11-3, 11-4 to 11-6 of the front panel 11 are inserted at the time of assembly are provided at positions in the GND plane 13b.

The connector 14 is connected to the main board 12 through a flexible portion 14a, thereby electrically connecting between the main board 12 to another board. The bracket 15 is made of metal and adhered to a surface of the main board 12 on which the CMOS image sensor 12a is not mounted by using an adhesive made of resin to be fixed thereto.

In the bracket 15, a cut-out hole 15a is provided at a place where the bracket 15 is to be brought into contact with the CMOS image sensor 12a so that the bracket 15 does not touch the CMOS image sensor 12a mounted on the main board 12 at the time of adhesion to the main substrate 12

Furthermore, screw holes 155-1 and 15s-2 are respectively provided on both ends of right and left in the bracket 15. Additionally, holes 15-1 to 15-3, 15-4 to 15-6 into which the protruding portions 11-1 to 11-3, 11-4 to 11-6 of the front panel 11 are inserted at the time of assembly are provided.

The spacers 16 are plural plate-shaped components having different thicknesses for adjusting the flange-focal length, which are arranged between the front panel 11 and the surface of the main board 12 on which the CMOS image sensor 12a is mounted (surface to which the bracket 15 is not adhered).

In FIG. 1, for example, the spacer 16-1a on the left side and the spacer 16-1b on the right side have the same thickness “d1”, similarly, the spacer 16-2a on the left side and the spacer 16-2b on the right side have the same thickness “d2” (≠d1).

As described above, the appropriate number of spacers 16 having adequate thicknesses are arranged between the front panel 11 and the surface of the main board 12 on which the CMOS image sensor is mounted. Accordingly, the length from a mount surface of a camera lens to the CMOS image sensor 12a can be adjusted (flange-focal length adjustment).

However, relative positions of the front panel 11 and the main board 12 on which the CMOS image sensor 12a is mounted differ every time in the flange-focal length adjustment as they are affected by variations in arranging these components.

Therefore, it is difficult to secure the accuracy of the flange-focal length adjustment when the front panel 11 and the main board 12 are fixed by screws with the spacers 16 sandwiched between the front panel 11 and the main board 12.

In response to the above, the bracket 15 is adhered to a rear surface (surface on which the CMOS image sensor 12a is not mounted) of the main board 12 by an adhesive, and the front panel 11 and the bracket 15 are fixed by screws with the spacers 16 sandwiched between the front panel 11 and the main board 12, thereby securing the accuracy of the flange-focal length adjustment.

On the other hand, as shown in FIG. 2, the sub board 13 is bent in a direction of an arrow in the drawing at a portion of the flexible portion 13a so that the GND plane 13b obtained by leading out the GND pattern of the main board 12 and mounting the led out GND pattern on one side of the sub board 13 is connected to a metal surface of the bracket 15 not adhered to the main board 12.

Then, the protruding portion 11-1 provided in the front panel 11 is inserted into the hole 15-1 of the bracket 15 and the hole 13-1 of the sub board 13, and the protruding portion 11-2 provided in the front panel 11 is inserted into the hole 2 of the bracket 15 and the hole 13-2 of the sub board 13 at the time of assembling the device.

Similarly, the projecting portion 11-3 provided in the front panel 11 is inserted into the hole 15-3 of the bracket 15 and the hole 13-3 of the sub board 13, and the protruding portion 11-4 provided in the front panel 11 is inserted into the hole 15-4 of the bracket 15 and the hole 13-4 of the sub board 13.

Furthermore, the projecting portion 11-5 provided in the front panel 11 is inserted into the hole 15-5 of the bracket 15 and the hole 13-5 of the sub board 13, and the protruding portion 11-6 provided in the front panel 11 is inserted into the hole 15-6 of the bracket 15 and the hole 13-6 of the sub board 13.

In a state after assembly shown in FIG. 3, the main board 12 is arranged between the front panel 11 and the bracket 15. The GND plane 13b of the sub board 13 is connected to the metal surface of the bracket 15 not adhered to the main board 12 in the state where the flexible portion 13a is folded and bent.

Then, the sub board 13, the bracket 15 and the front panel 11 are fastened together (joint) by the metal screws s1 and s2 in the above positional relation.

That is, the screw hole 139-1 of the sub board 13 and the screw hole 15s-1 of the bracket 15 are pierced by the screw s1, which is fastened to the screw seat 11a of the front panel 11.

Similarly, the screw hole 13s-2 of the sub board 13 and the screw hole 15s-2 of the bracket 15 are pierced by the screw s2, which is fastened to the screw seat 11b of the front panel 11.

Here, as the front panel 11 is grounded, the bracket 15 is also electrically connected to the ground because the front panel 11 and the bracket 15 are fastened together by the metal screws s1 and s2. Additionally, the GND plane 13b of the sub board 13 is connected to the bracket 15.

The GND plane 13b is obtained by leading out the GND pattern of the main board 12 through the flexible portion 13a. Therefore, the GND pattern of the main substrate 12 is also electrically connected to the ground.

As explained above, the GND plane 13b of the sub board 13 is connected to the surface of the bracket 15 in the state where the flexible portion 13a is folded and bent in the front portion 101 of the camera device 10.

Then, the sub board 13, the bracket 15 and the front panel 11 are fastened together by the metal screws s1 and s2 in the state where the main substrate 12 is sandwiched between the front panel 11 and the bracket 15, thereby electrically connecting the GND pattern of the main board 12 to the front panel 11 to be grounded.

It is possible to improve electrical characteristics by securing the ground of the main board 12. Additionally, as the ground can be secured without using the thin-line coaxial cable and so on, application to small-sized products can be realized.

Furthermore, the flange-focal length adjustment can be performed while securing the ground of the main board 12, and further, the flexible portion 13a is directly connected to the main substrate 12, which is effective for releasing heat in the main board 12.

When the sub board 13 is folded and connected to the bracket 15, the sub board 13 is connected to the surface of the bracket 15 so as to cover the cut-out hole 15a provided in the bracket 15.

As a result, unnecessary radiation waves radiated from the main board 12 through the cut-out hole 15a or unnecessary radiation waves entering through the cut-out hole 15a can be suppressed, thereby obtaining shielding effect.

Next, a rear portion of the camera device 10 will be explained. Problems to be solved in the rear portion will be explained first.

In a camera to be incorporated in another device such as a MV camera, the reduction in outside dimension is requested. On the other hand, the camera device with the high resolution and high speed is being developed, therefore, the number of substrates to be mounted and structural components used for heat release are increasing.

Accordingly, in order to secure the space where the substrates are mounted and to secure the mounting space on the substrate, a no-screw structure in which screw fastening is not used in a substrate fixing mechanism is being considered.

In the above situation, a rigid flexible substrate which can connect substrates to each other through the flexible portion is widely used as the substrates to be used. In the related-art substrate fixing mechanism, the rigid flexible substrate is inserted into a slit to fix an upper portion of the substrate to be positioned.

That is, the substrate is inserted into the slit provided in a die-cast portion. In this case, the rigid flexible substrate has flexibility at the flexible portion and can be deformed, therefore, the substrate is not fixed to a predetermined position when inserted into the slit (the substrate becomes unstable).

Accordingly, the positioning is performed by putting a holder as a resin component from an upper part of the substrate and pushing a sheet-metal cover as an exterior component from an upper part of the holder to be assembled, thereby fixing the substrate.

However, as the number of rigid flexible substrates is increased, assembly work of fixing the rigid flexible substrates at predetermined positions becomes complicated in the related-art mechanism, which may reduce the productivity.

The technology of the present disclosure has been made also in view of the above point, and there is provided an electronic apparatus and a flexible chassis aiming for improving productivity by facilitating the assembly work.

Subsequently, the application to the rear portion of the camera device 10 will be explained below as an example of the electronic apparatus according to the embodiment of the present disclosure. The substrate fixing mechanism in the rear portion of the camera device 10 includes a substrate unit and a flexible chassis for fixing the substrates.

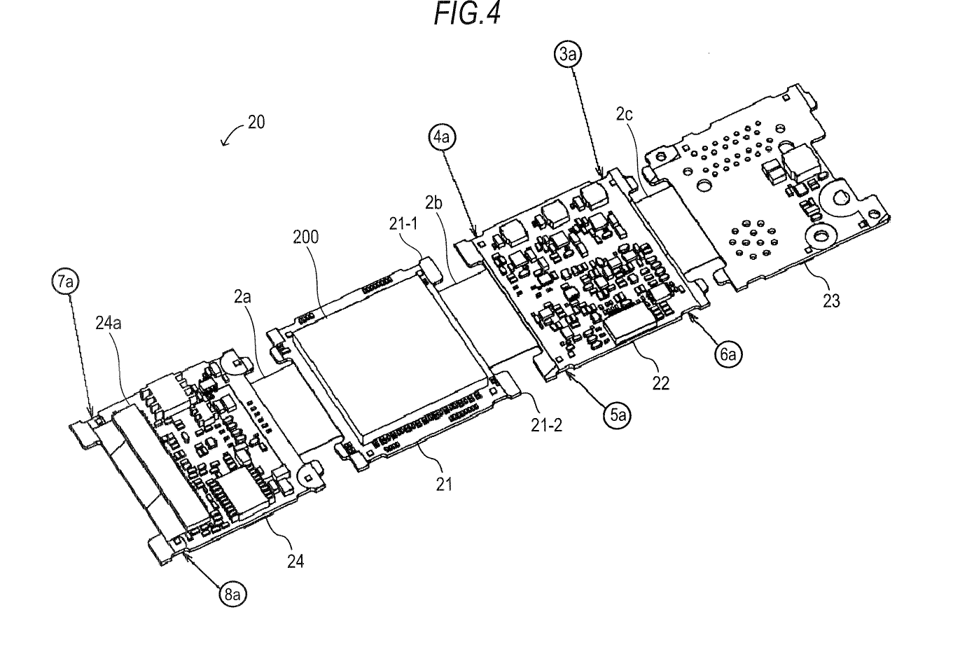

FIG. 4 is a view showing a structure example of the substrate unit. A substrate unit 20 to be mounted on the camera device 10 has a structure in which plural substrates (four substrates in the shown example) on which various semiconductor components are mounted are connected through flexible portions.

In the shown example, the substrate unit 20 includes substrates (rigid portions) 21 to 24. On the substrate 21, a heating component 200 such as a FPGA (Field-Programmable Gate Array) is mounted. On the substrate 24, a connector 24a for connecting to the front portion 101 shown in FIG. 1 to FIG. 3 is mounted.

The substrates 21 and 24 are connected through a flexible portion 2a, the substrates 21 and 22 are connected through a flexible portion 2b and the substrates 22 and 23 are connected through a flexible portion 2c.

At an end portion of the substrate 21, protruding portions (leg portions) 21-1 and 21-2 to be inserted into slits of the later-described flexible chassis are provided. The substrate 22 are provided with cut-out portions 3a, 4a, 5a and 6a to which protruding portions (claw portions) of the later-described flexible chassis are fitted. The substrate 24 is provided with cut-out portions 7a and 8a to which claw portions of the later-described flexible chassis are fitted.

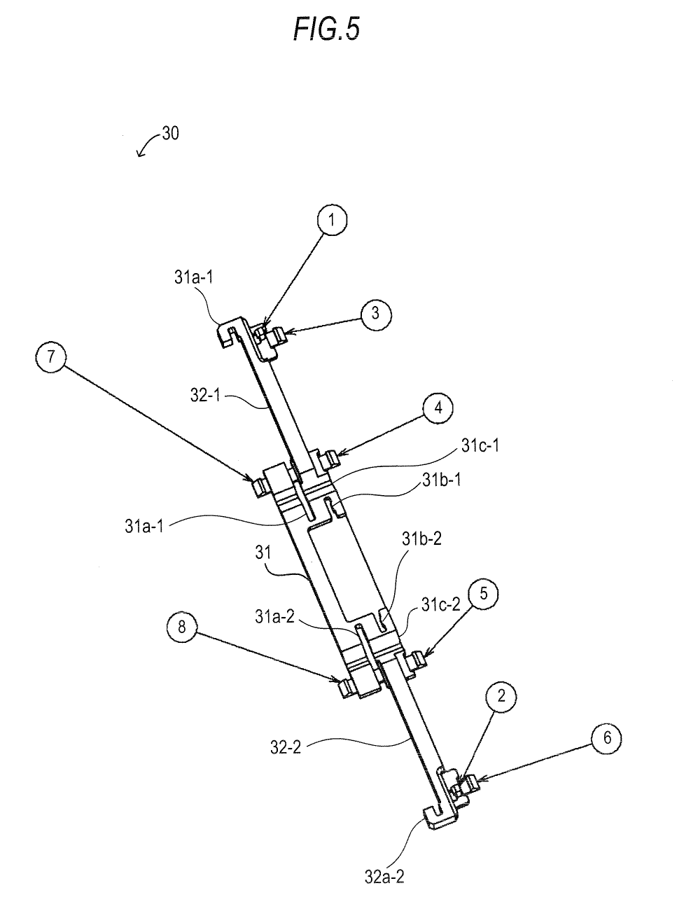

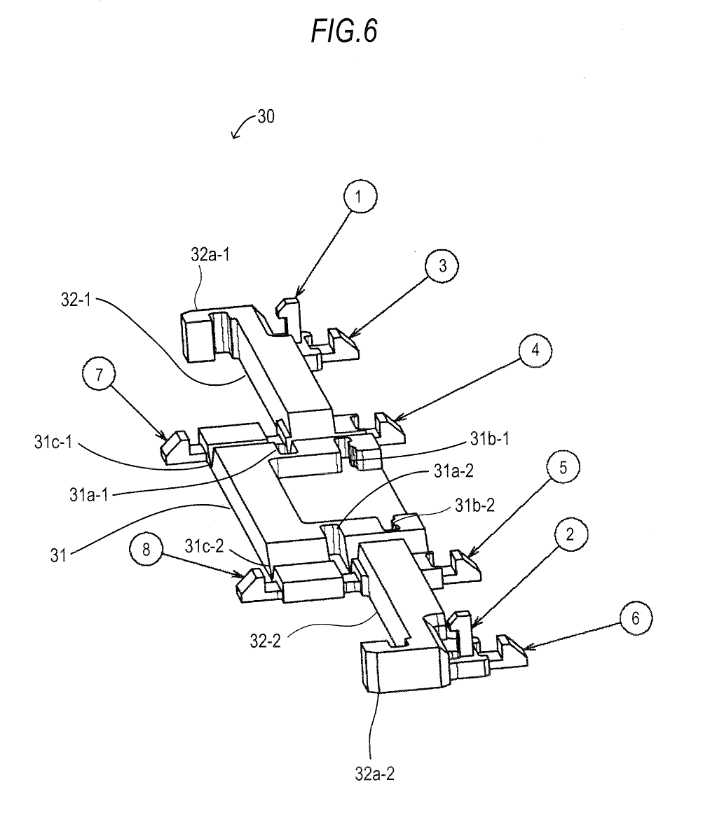

FIG. 5 and FIG. 6 are views showing a structure example of the flexible chassis. A flexible chassis 30 is made of resin, which is the chassis capable of fixing substrates by a snap-fit mechanism, including a slit portion 31 and arm portions 32-1, 32-2.

The slit unit 31 includes slits 31a-1 and 31a-2 into which the substrate is inserted and slits for a heat sink 31b-1 and 31b-2 into which a heat sink is inserted. At both ends of the slit portion 31, hinges 31c-1 and 31c-2 which can be folded are provided.

The arm portion 32-1 is connected to the slit portion 31 through the hinge 31c-1 and the arm portion 32-2 is connected to the slit portion 31 through the hinge 31c-2. The arm portion 32-1 includes a hook portion 32a-1 and claw portions 1, 3, 4 and 7, and the arm portion 32-2 includes a hook portion 32a-2 and claw portions 2, 5, 6 and 8.

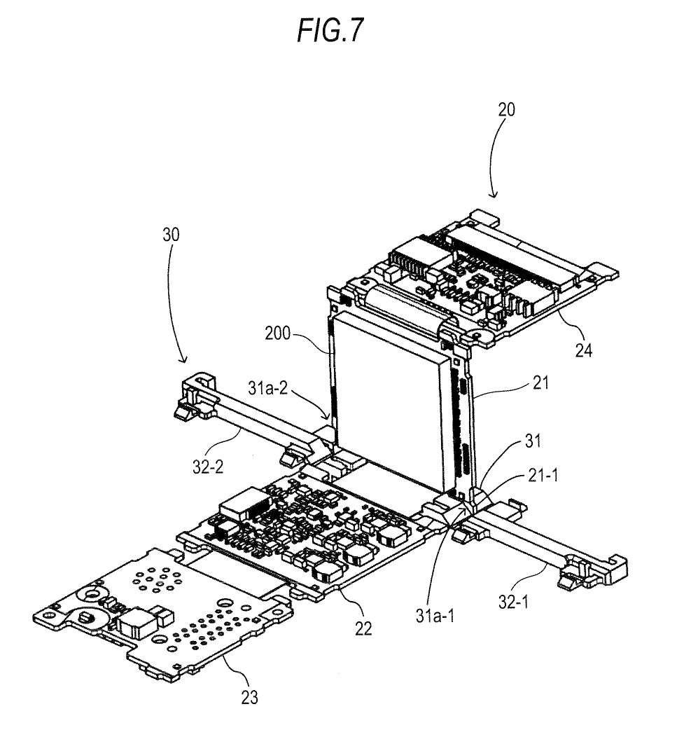

Next, the assembly of the substrate unit 20 to the flexible chassis 30 will be explained in detail in stages. FIG. 7 to FIG. 18 are views for explaining fixing and installation of the substrates by the flexible chassis.

FIG. 7 shows a state where the substrate unit 20 is inserted into the slit portion 31 of the flexible chassis 30. Specifically, the leg portions 21-1 and 21-2 of the substrate 21 in the substrate unit 20 are respectively inserted into the slits 31a-1 and 31a-2 of the slit portion 31 in the flexible chassis 30.

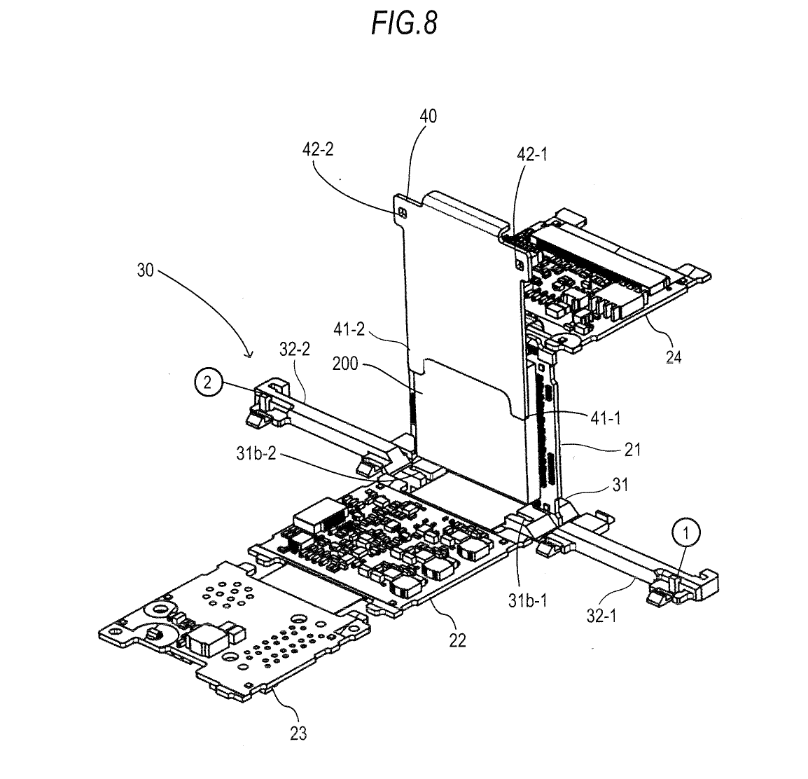

FIG. 8 shows a state before a heat sink 40 is inserted into the slit portion 31 in the flexible chassis 30. The heat sink 40 is provided with leg portions 41-1 and 41-2 to be inserted into the slits for the heat sink 31b-1 and 31b-2 of the slit portion 31 in the flexible chassis 30. The heat sink 40 is also provided with holes 42-1 and 42-2 to which the claw portion 1 in the arm portion 32-1 and the claw portion 2 in the arm portion 32-2 are fitted.

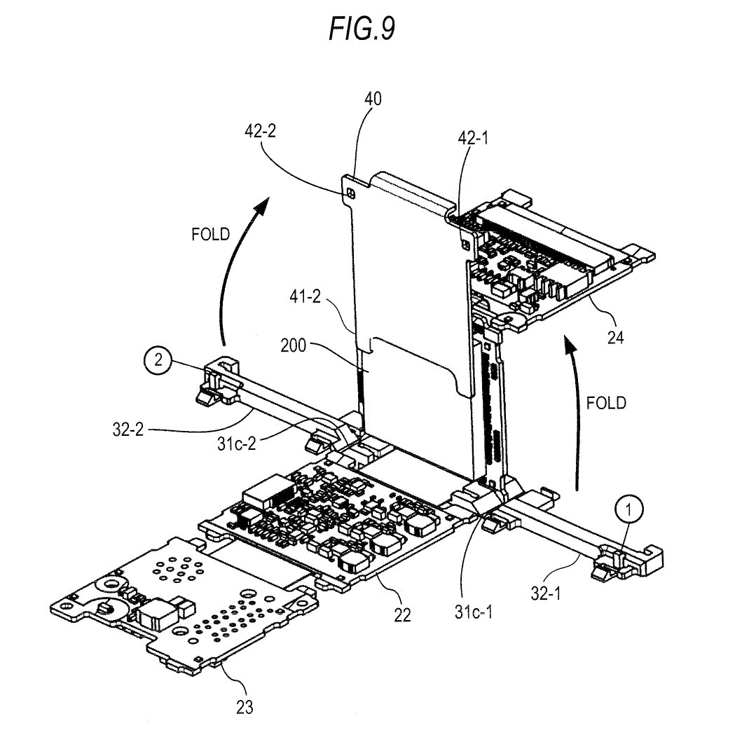

FIG. 9 shows movable directions of the arm portions 32-1 and 32-2. The arm portions 32-1 and 32-2 are moved in directions of arrows in the drawing by folding the hinges 31c-1 and 31c-2.

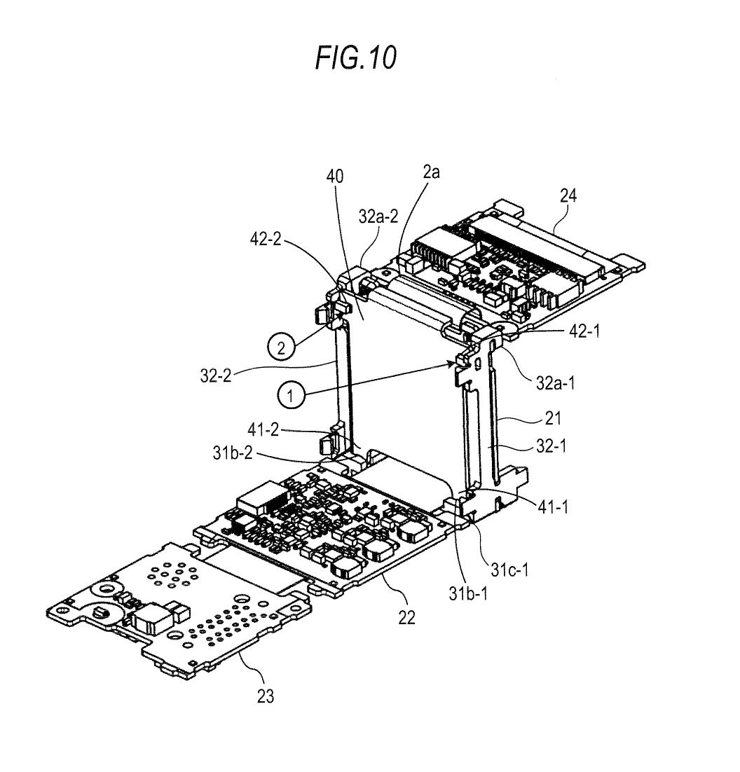

FIG. 10 shows a state where the hinges 31c-1 and 31c-2 are folded and the arm portions 32-1 and 32-2 are moved. The heat sink 40 is inserted into the slit port on 31 in the flexible chassis 30.

Furthermore, the substrate 21 and the heat sink 40 are fixed to the flexible chassis 30 by the arm portions 32-1 and 32-2 moved by folding the hinges 31c-1 and 31c-2.

In this case, the leg portions 41-1 and 41-2 are respectively inserted into the slits for the heat sink 31b-1 and 31b-2 of the slit portion 31 in the flexible chassis 30.

The arm portion 32-1 is folded at the hinge 31c-1 and moves to the vertical direction with respect to the slit portion 31. The arm portion 32-2 is folded at the hinge 31c-2 and moves to the vertical direction with respect to the slit portion 31-1.

At this time, the hook portion 32a-1 provided at a tip of the arm portion 32-1 is fitted to an upper end portion of the substrate 21. Then, the claw portion 1 provided at the tip of the arm portion 32-1 is fitted to the hole 42-1 of the heat sink 40.

Similarly, the hook portion 32-2 provided at a tip of the arm portion 32-2 is fitted to the upper end portion of the substrate 21. Then, the claw portion 2 provided at the tip of the arm portion 32-2 is fitted to the hole 42-2 of the heat sink 40.

As explained above, the substrate unit 20 is mounted by using the flexible chassis 30 having the hinge mechanism. As the slits 31a-1 and 31a-2 into which the substrate 21 is inserted are provided in the flexible chassis 30 in this case, positioning of the substrate 21 in front-rear and right-left directions can be performed first.

As the slits 31b-1 and 31b-2 for the heat sink into which the heat sink 40 can be inserted are further provided in the flexible chassis 30, the heat sink 40 can be positioned in the vicinity of the substrate 21 on which the heating component 200 is mounted.

Then, the right and left hinges 31c-1 and 31c-2 are folded in the state where the substrate 21 is inserted into the slits 31a-1 and 31a-2 and the heat sink 40 is inserted into the slits 31b-1 and 31b-2 for the heat sink, thereby moving the arm portions 32-1 and 32-2 on the both sides in the upper direction.

The hook portions 32a-1 and 32a-2 provided in the arm portions 32-1 and 32-2 are fitted to the upper end portion of the substrate 21. Moreover, the holes 42-1 and 42-2 are provided in the heat sink 40, and the claw portions 1 and 2 provided in the arm portions 32-1 and 32-2 are respectively fitted to the holes 42-1 and 42-2. The substrate 21 and the heat sink 40 can be fixed and installed by the flexible chassis 30 by the above assembly.

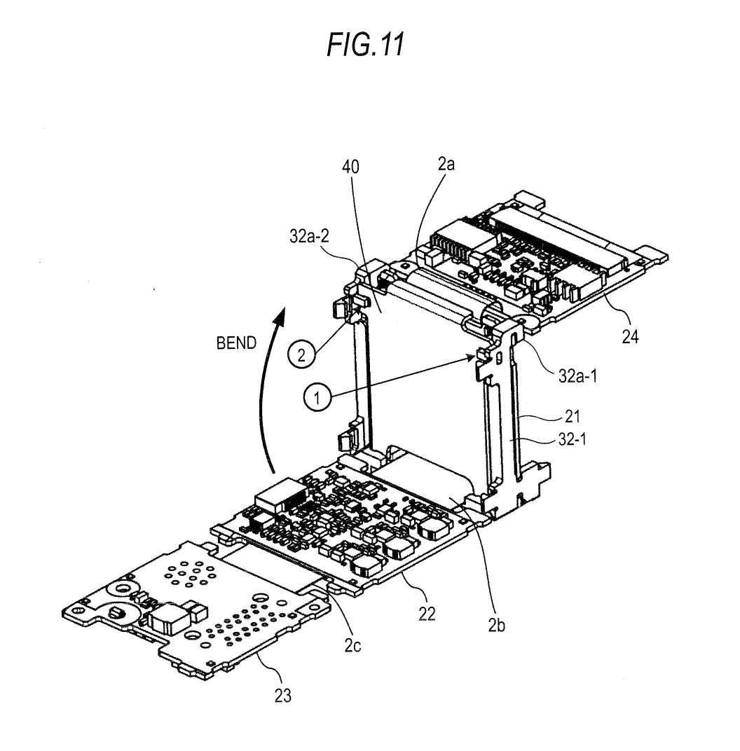

Next, a mechanism for fixing the substrates 22 to 24 will be explained in stages. FIG. 11 shows a movable direction of the substrate 22. The substrate 22 is moved in a direction of an arrow in the drawing by bending the flexible portion 2b.

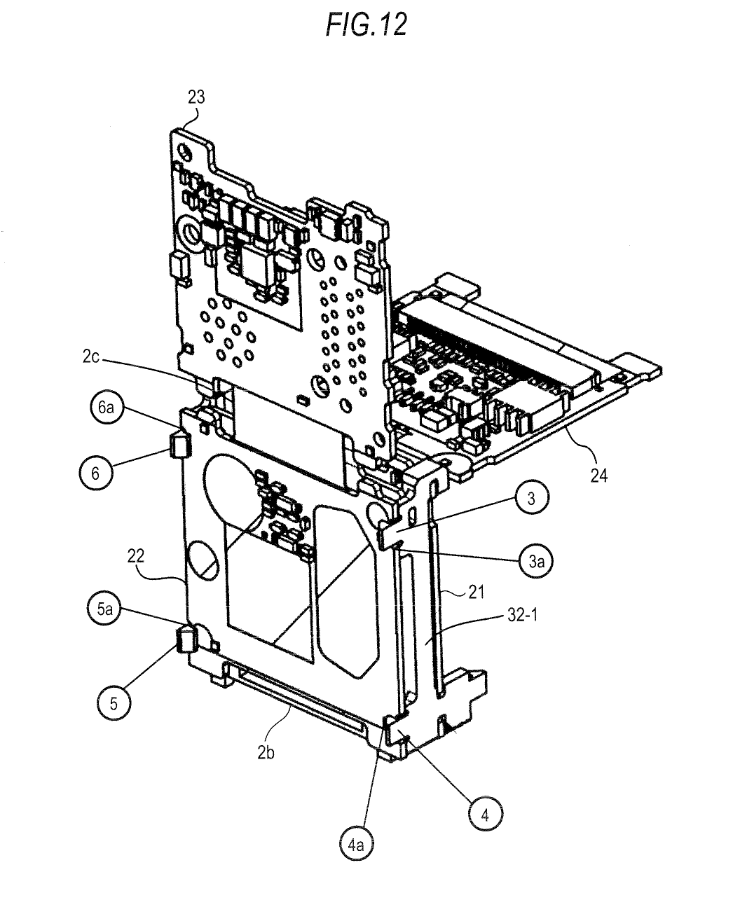

FIG. 12 shows a state where the substrate 72 is bent at the flexible portion 2b and fixed by the arm portions 32-1 and 32-2 in the flexible chassis 30.

In this case, the claw portion 3 provided in the arm portion 32-1 is fitted to the cut-out portion 3a of the substrate 22, and the claw portion 4 provided in the arm portion 32-1 is fitted to the cut-out portion 4a of the substrate 22.

Furthermore, the claw portion 6 provided in the arm portion 32-2 is fitted to the cut-out portion 6a of the substrate 22, and the claw portion 5 provided in the arm portion 32-2 is fitted to the cut-out portion 5a of the substrate 22. The substrate 22 can be fixed to the arm portions 32-1 and 32-2 of the flexible chassis 30 easily by the above snap-fit mechanism.

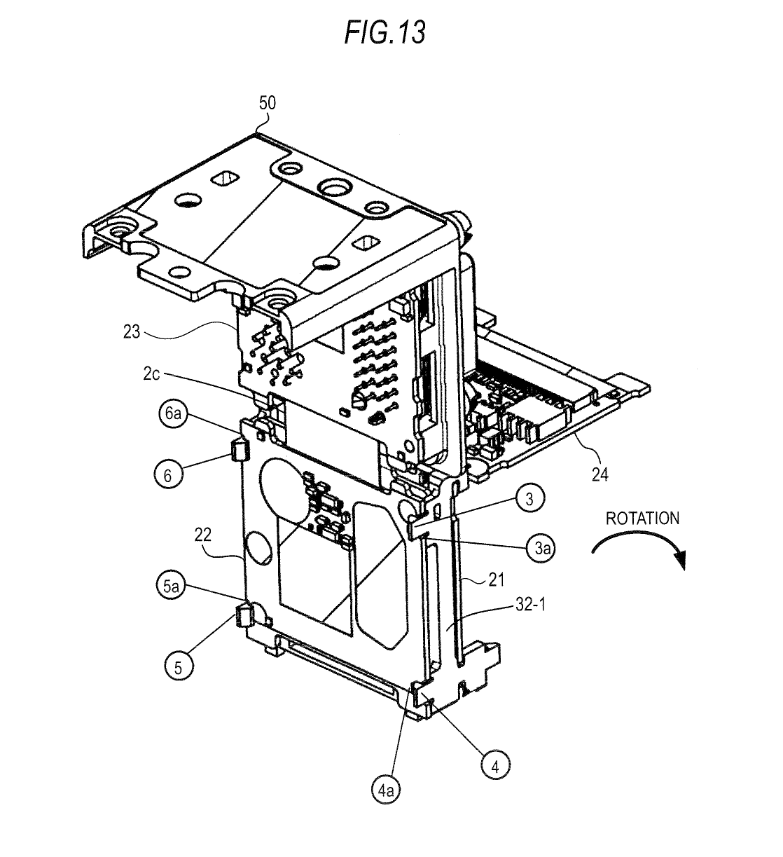

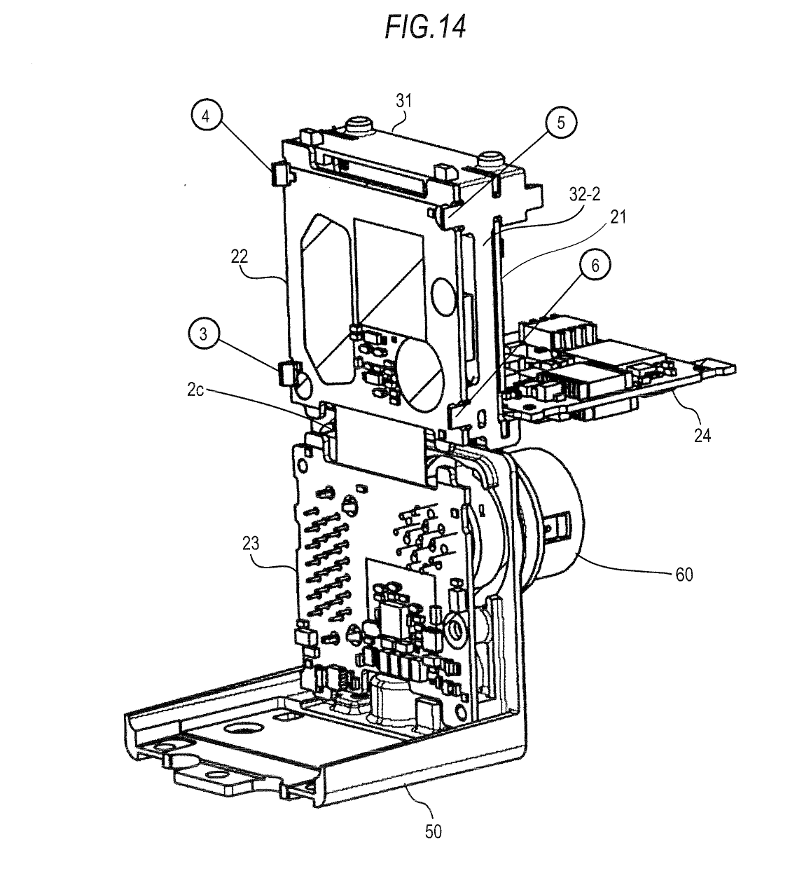

FIG. 13 and FIG. 14 show a state where a rear panel 50 is set at an upper end portion of the substrate 23. The rear panel 50 is mounted on the upper end portion of the substrate 23 by soldering a not-shown pin of connector which is attached to the rear panel 50 and a given place of the substrate 23.

FIG. 14 shows a state where the structure shown in FIG. 13 is rotated in a direction of an arrow to change the orientation. In FIG. 14, a cable connector 60 is connected to the substrate 23 through the rear panel 50.

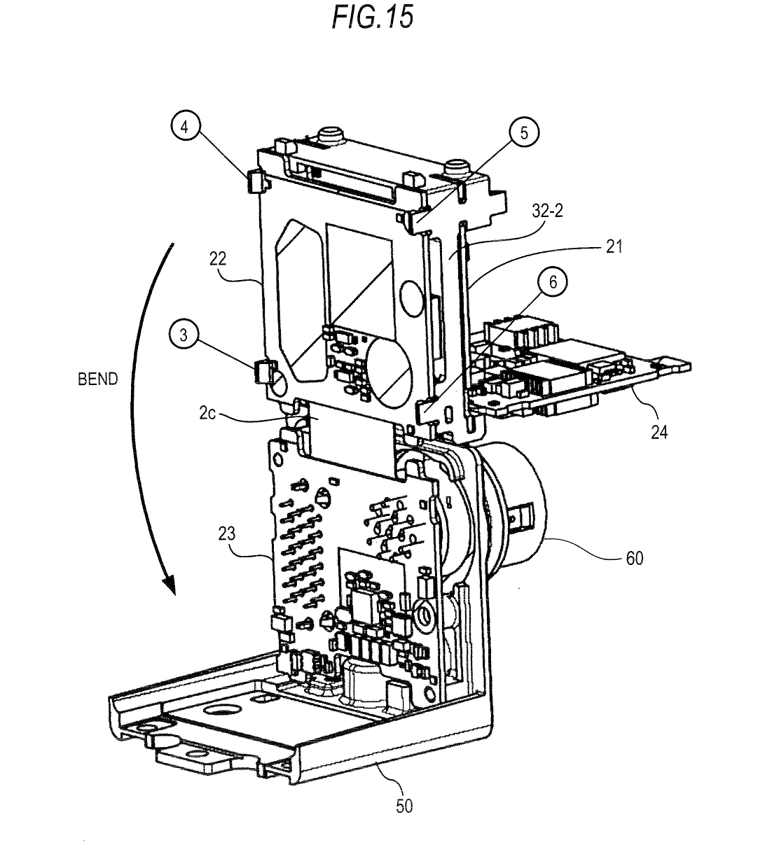

FIG. 15 shows a movable direction of the substrates 21, 22 and the heat sink 40 which are fixed by the arm portions 32-1 and 32-2 of the flexible chassis 30. The substrates 21, 22 and the heat sink 40 integrated with one another by the arm portions 32-1 and 32-2 are moved with respect to an arrow direction in the drawing by bending the flexible portion 2c.

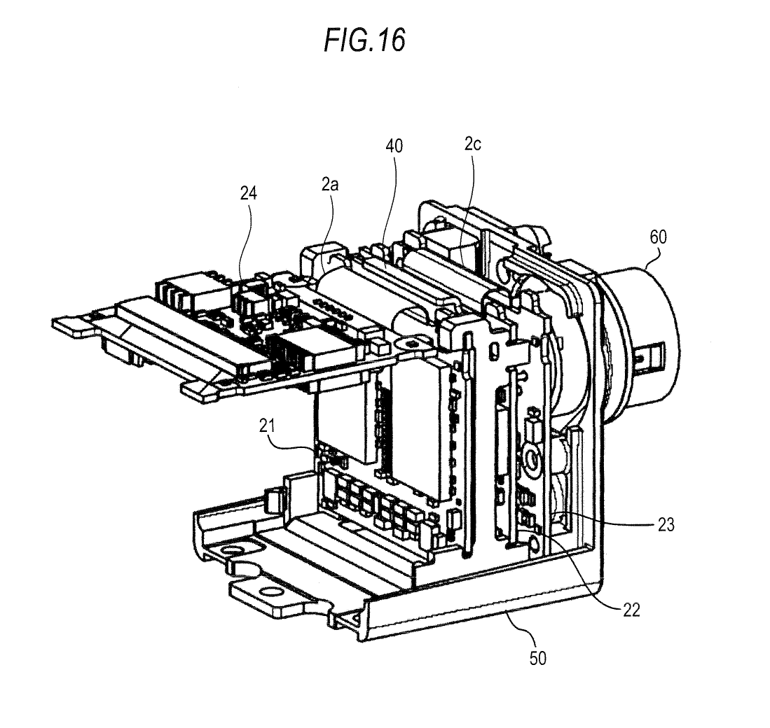

FIG. 16 shows a state where the substrates 21, 22 and the heat sink 40 integrated with one another by the arm portions 32-1 and 32-2 are mounted on the rear panel 50 by bending the flexible portion 2c.

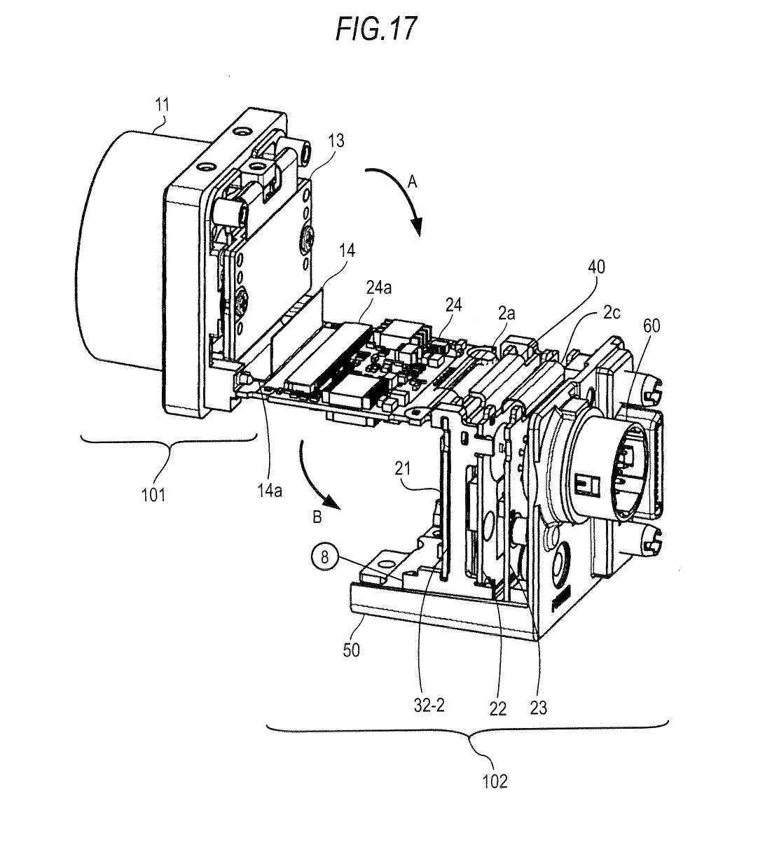

FIG. 17 shows a state of connecting the front portion 101 of the camera device 10 the assembly mechanism of which has been shown with reference to FIG. 1 to FIG. 3 to a rear portion 102 of the camera device 10. When the front portion 101 is connected to the rear portion 102, the connector 14 of the front portion 101 is fitted to the connector 24a mounted on the substrate 24. Accordingly, the front portion 101 is electrically connected to the rear portion 102.

An arrow A in the drawing shows a movable direction of the front portion 101 and an arrow B shows a movable direction of the substrate 24. After the front portion 101 is attached to the rear portion 102, the front portion 101 is moved in the direction of the arrow A by bending the flexible portion 14a. Also, the substrate 24 is moved in the direction of the arrow B by bending the flexible portion 2a.

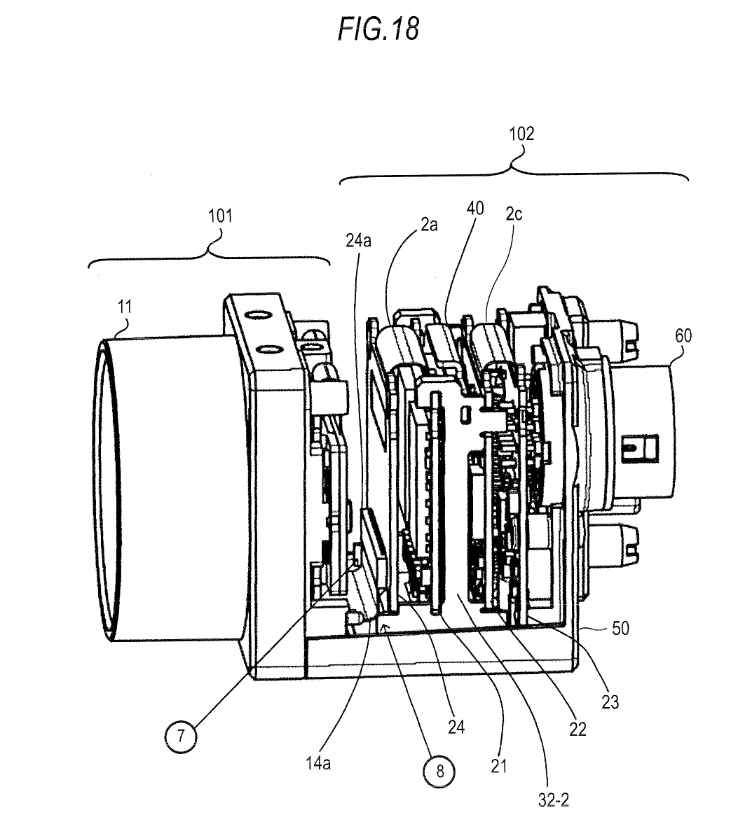

FIG. 18 shows a state where the front portion 101 and the substrate 24 are fixed. The connector 14 of the front portion 101 is fitted to the connector 24a mounted on the substrate 24 in the state where the flexible portion 14a is bent.

The substrate 24 moved by bending the flexible portion 2a is fixed to the flexible chassis 30. In this case, the claw portion 7 provided in the arm portion 32-1 is fitted to the cut-out portion 7a of the substrate 24 and the claw portion 8 provided in the arm portion 32-2 is fitted to the cut-out portion 8a of the substrate 24. The substrate 24 can be fixed to the arm portions 32-1 and 32-2 of the flexible chassis 30 easily by the snap-fit mechanism described above.

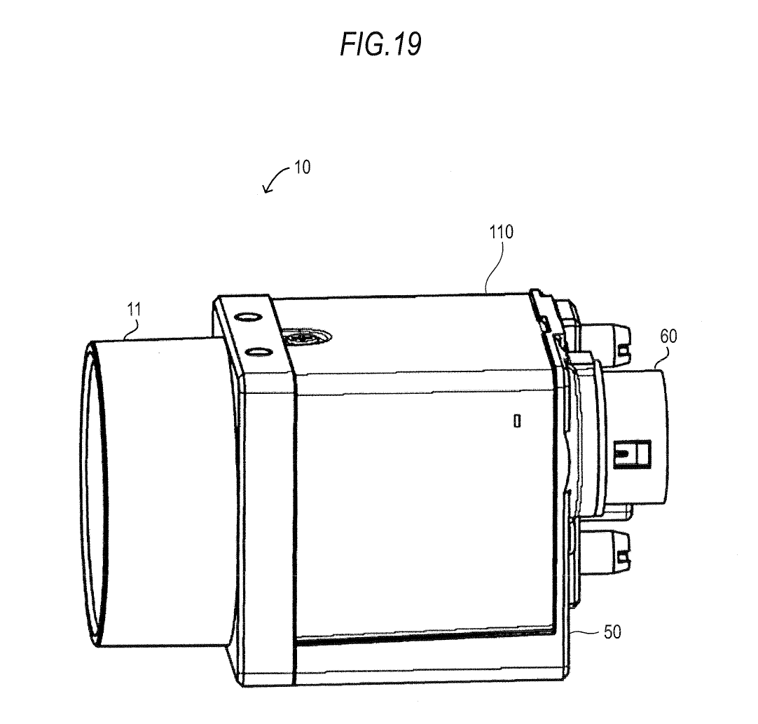

FIG. 19 is a view showing an outline of the camera device. Lastly, a holder 110 as a resin component is put on the structure shown in FIG. 18 from the upper end of the substrates to be fixed.

As described above, the substrate unit 20 including the first to n-th substrates connected through the flexible portions and the flexible chassis 30 are included in the rear portion 102 of the camera device 10.

The first substrate is inserted into the slits of the flexible chassis 30 and the arm portions are moved by folding the hinges from right and left of the first substrate to fix the first substrate by hooks provided in the arm portions.

Then, the remaining second to n-th substrates are stacked by bending the substrates through the flexible portions and the stacked second to n-th substrates are fitted and fixed by the protruding portions provided in the arm portions.

According to the above, the substrates can be fixed at given positions easily by using the flexible chassis even when the number of substrates is increased, which facilitates assembly work and improves productivity.

The present disclosure may be implemented as the following configurations.

(1) A camera device including

a metal panel to be grounded,

a main board on which a CMOS imaging device is mounted,

a sub board having a ground plane obtained by leading out a ground pattern of the main board through a flexible portion and mounting the led-out ground pattern, which is connected to the main board through the flexible portion and

a metal support plate one surface of which is fixed to the main board through an adhesive layer,

in which the ground plane of the sub board is connected to the other surface of the support plate by bending the flexible plate, which electrically connects the ground pattern of the main board to the panel through the support plate to be grounded.

(2) The camera device described in the above (1),

in which the ground plane of the sub board is connected to the other surface of the support plate in the state where the flexible portion is folded and bent, and the sub board, the support plate and the panel are fastened together by metal screws in the state where the main board is sandwiched between the panel and the support plate, thereby electrically connecting the ground pattern of the main board to the panel to be grounded.

(3) The camera device described in the above (1) or (2),

in which the support plate is provided with a cut-out hole so as not to touch the CMOS imaging device mounted on the main board and is fixed to one surface of the main board through the adhesion layer at portions other than the cut-out hole, and

the sub board is connected to the other surface of the support plate so as to cover the cut-out hole of the support plate in the state where the flexible portion is folded and bent.

(4) The camera device described in any of the above (1) to (3),

in which plural spacers having different thicknesses for adjusting a flange focal length are arranged between the panel and a surface of the main board to which the support plate is not fixed.

(5) An electronic apparatus including

a substrate unit in which the first to n-th substrates are connected through flexible portions, and

a flexible chassis having a slit portion in which slits are formed and two arm portions connecting to both ends of the slit portion through hinges which can be folded provided at both ends of the slit portion.

(6) The electronic apparatus described in the above (5)

in which the first substrate is inserted into the slits and the arm portions are moved by folding the hinges from right and left of the first substrate to fix the first substrate by hooks provided in the arm portions, and

the remaining second to n-th substrates are stacked by bending the flexible portions and the stacked second to n-th substrates are fitted and fixed by protruding portions provided in the arm portions.

(7) The electronic apparatus described in the above (5) or (6),

in which slits for a heat sink into which the heat sink is inserted are formed in the slit portion of the flexible chassis.

(8) A flexible chassis including

a slit portion in which slits are formed, and

two arm portions connecting to both ends of the slit portion through hinges which can be folded provided at both ends of the slit portion.

(9) The flexible chassis described in the above (8),

in which with respect to a substrate unit in which a first to n-th substrates are connected through flexible portions, the arm portions are moved by folding the hinges from right and left of the first substrate inserted into the slits to fix the first substrate by hooks provided in the arm portions, and

the remaining second to n-th substrates stacked by bending the flexible portions are fitted and fixed by protruding portions provided in the arm portions.

(10) The flexible chassis described in the above (8) or (9),

in which slits for a heat sink into which the heat sink is inserted are formed in the slit portion.

The embodiments described above may be modified variously within the extent not departing from the gist of embodiments of the present disclosure.

Also, the embodiments described above can be variously changed and altered by those skilled in the art and embodiments of the present disclosure are not limited to those having the disclosed configurations or applications exactly.

The present disclosure contains subject matter related to that disclosed in Japanese Priority Patent Application JP 2012-033940 filed in the Japan Patent Office on Feb. 20, 2012, the entire contents of which are hereby incorporated by reference.

What is claimed is:

1. A camera device comprising:
a metal panel to be grounded;
a main board on which a CMOS imaging device is mounted;
a sub board having a ground plane obtained by leading out a ground pattern of the main board through a flexible portion and mounting the led-out ground pattern, which is connected to the main board through the flexible portion; and
a metal support plate one surface of which is fixed to the main board through an adhesive layer,
wherein the ground plane of the sub board is connected to the other surface of the support plate by bending the flexible plate, which electrically connects the ground pattern of the main board to the panel through the support plate to be grounded.

2. The camera device according to claim 1,
wherein the ground plane of the sub board is connected to the other surface of the support plate in the state where the flexible portion is folded and bent, and the sub board, the support plate and the panel are fastened together by metal screws in the state where the main board is sandwiched between the panel and the support plate, thereby electrically connecting the ground pattern of the main board to the panel to be grounded.

3. The camera device according to claim 1,
wherein the support plate is provided with a cut-out hole so as not to touch the CMOS imaging device mounted on the main board and is fixed to one surface of the main board through the adhesion layer at portions other than the cut-out hole, and
the sub board is connected to the other surface of the support plate so as to cover the cut-out hole of the support plate in the state where the flexible portion is folded and bent.

4. The camera device according to claim 1,
wherein plural spacers having different thicknesses for adjusting a flange focal length are arranged between the panel and a surface of the main board to which the support plate is not fixed.

5. An electronic apparatus comprising:
a substrate unit in which the first to n-th substrates are connected through flexible portions; and
a flexible chassis having a slit portion in which slits are formed and two arm portions connecting to both ends of the slit portion through hinges which can be folded provided at both ends of the slit portion.

6. The electronic apparatus according to claim 5,
wherein the first substrate is inserted into the slits and the arm portions are moved by folding the hinges from right and left of the first substrate to fix the first substrate by hooks provided in the arm portions, and
the remaining second to n-th substrates are stacked by bending the flexible portions and the stacked second to n-th substrates are fitted and fixed by protruding portions provided in the arm portions.

7. The electronic apparatus according to claim 5,
wherein slits for a heat sink into which the heat sink is inserted are formed in the slit portion of the flexible chassis.

8. A flexible chassis comprising:
a slit portion in which slits are formed; and
two arm portions connecting to both ends of the slit portion through hinges which can be folded provided at both ends of the slit portion.

9. The flexible chassis according to claim 8,
wherein with respect to a substrate unit in which a first to n-th substrates are connected through flexible portions, the arm portions are moved by folding the hinges from right and left of the first substrate inserted into the slits to fix the first substrate by hooks provided in the arm portions, and
the remaining second to n-th substrates stacked by bending the flexible portions are fitted and fixed by protruding portions provided in the arm portions.

10. The flexible chassis according to claim 8,
wherein slits for a heat sink into which the heat sink is inserted are formed in the slit portion.
